(19) United States
(12) Patent Application Publication
(10) Pub. No.: US 2011/0243222 A1
(43) Pub. Date: Oct. 6, 2011

(54) METHOD AND APPARATUS FOR ENCODING VIDEO BY USING ADAPTIVE PREDICTION FILTERING, METHOD AND APPARATUS FOR DECODING VIDEO BY USING ADAPTIVE PREDICTION FILTERING

(75) Inventors: Byeong-doo CHOI, Siheung-si (KR); Tammy LEE, Seoul (KR); Dae-sung CHO, Seoul (KR)

(73) Assignee: SAMSUNG ELECTRONICS CO., LTD., Suwon-si (KR)

(21) Appl. No.: 13/080,153

(22) Filed: Apr. 5, 2011

Related U.S. Application Data
(60) Provisional application No. 61/320,847, filed on Apr. 5, 2010.

(30) Foreign Application Priority Data
Jan. 20, 2011 (KR) 10-2011-0005982

(51) Int. Cl. H04N 7/26

(52) U.S. Cl. 375/240.03; 375/240.14; 375/E07.243; 375/E07.14

(57) ABSTRACT

Encoding and decoding a video using adaptive prediction filtering by encoding prediction filter information in a video bitstream and decoding the video bitstream using the prediction filter information.

### CROSS-REFERENCE TO RELATED PATENT APPLICATION

This application claims the benefit of U.S. Provisional Patent Application No. 61/320,847, filed on Apr. 5, 2010, in the U.S. Patent and Trademark Office, and priority from Korean Patent Application No. 10-2011-0005982, filed on Jan. 20, 2011, in the Korean Intellectual Property Office, the disclosures of which are incorporated herein by reference in their entireties.

### BACKGROUND

1. Field

One or more aspects of the exemplary embodiments relate to video encoding/decoding using an in-loop filter for prediction coding.

2. Description of the Related Art

According to video compression technologies, in order to encode a block of a current image, motion prediction/compensation, in which a most similar block of the current image is used as prediction data, is performed, or discrete cosine transform (DCT) is performed to encode a differential signal between a previous image and a current image. In addition, a deblocking filter has been used as an in-loop filter to improve subjective image quality, as well as objective image quality, to thus perform precision motion prediction/compensation during encoding. Further, a post filter has been used to minimize the amount of errors between a restored image and an original image.

By virtue of the development and spread of hardware for reproducing and storing video contents having high resolution or high quality, a need for a video codec for effectively encoding or decoding video contents having high resolution or high quality has increased. In a typical video codec, a video is encoded according to a limited encoding method based on a macroblock having a predetermined size. In addition, in the typical video codec, the macroblock is transformed and inverse transformed by using a block having a predetermined size to encode and decode video data.

### SUMMARY

According to an exemplary embodiment, there is provided a method of encoding a video, the method including performing motion compensation and intra prediction on a first image of the video and generating a first prediction image from the motion compensated and intra predicted first image; generating a prediction filter based on at least one of characteristics of the first image and characteristics of the first prediction image; filtering the first prediction image using the generated prediction filter and generating a second prediction image from the filtered first prediction image; generating a differential signal between the generated second prediction image and a second image of the video; encoding the generated differential signal; and outputting the encoded differential signal and encoded prediction filter information, the encoded prediction filter information identifying characteristics of the prediction filter that permits reconstruction of the prediction filter by a decoding apparatus that receives the output encoded prediction filter information.

The prediction filter may be a applied to maximize an encoding efficiency of a differential signal.

According to another exemplary embodiment, there is provided a method of decoding a video, the method including parsing a received bitstream and extracting prediction filter information that identifies characteristics of a prediction filter characteristics of a prediction filter that encodes the video and an encoded differential signal between a first image of the video and a second image of the video from the parsed bitstream; performing at least one of motion compensation or intra prediction on a restored image of the first image to generate a first prediction image of the first image; generating the prediction filter, based on the prediction filter information, and filtering the first prediction image using the generated prediction filter and generating a second prediction image from the filtered first prediction image; and synthesizing the second prediction image and the differential signal to restore the second image.

According to another aspect of the present invention, there is provided a video encoding apparatus including a prediction image generator that performs motion compensation and intra prediction on a first image of a video and generates a first prediction image from the motion compensated and intra predicted first image; a prediction filtering unit that generates a prediction filter based on at least one of characteristics of the first image and characteristics of the first prediction image filters the first prediction image using the generated prediction filter, and generates a second prediction image from the filtered first prediction image; an image encoder that generates a differential signal between the generated second prediction image and a second image of the video and encodes the generated; and an output unit that outputs the encoded differential signal and encoded prediction filter information, the encoded prediction filter information identifying characteristics of the prediction filter that permits reconstruction of the prediction filter by a decoding apparatus that receives the output encoded prediction filter information.

According to another aspect of the present invention, there is provided a video decoding apparatus including a data extractor that parses a received bitstream and extracts prediction filter information that identifies characteristics of a prediction filter characteristics of a prediction filter that encodes a video in the bitstream and an encoded differential signal between a first image the video and a second image of the video from the bitstream; a differential signal decoder that entropy decodes, inverse quantizes, and inverse transforms the encoded differential signal; a prediction image generator that performs motion compensation or intra prediction on a restored image of the first image; a prediction filtering unit that generates the prediction filter, based on the prediction filter information, filters the first prediction image using the generated prediction filter, and generates a second prediction image from the filtered first prediction image; and an image restorer that synthesizes the second prediction image and the differential signal to restore the second image.

### BRIEF DESCRIPTION OF THE DRAWINGS

The above and/or other aspects will become more apparent by describing in detail exemplary embodiments thereof with reference to the attached drawings in which:

FIG. 1 is a block diagram of a video encoding apparatus employing adaptive prediction filtering, according to an exemplary embodiment;

FIG. 2 is a block diagram of a video decoding apparatus employing adaptive prediction filtering, according to an exemplary embodiment;

FIG. 3 is a detailed block diagram of a video encoding apparatus employing adaptive prediction filtering, according to an exemplary embodiment;

FIG. 4 is a detailed block diagram of a video decoding apparatus employing adaptive prediction filtering, according to an exemplary embodiment;

FIG. 5 is a diagram of a structure of a bitstream including prediction filter information about adaptive prediction filtering, according to an exemplary embodiment;

FIG. 6 is a block diagram of an apparatus for encoding a video employing adaptive prediction filtering based on a coding unit having a tree structure, according to an exemplary embodiment;

FIG. 7 is a block diagram of an apparatus for decoding a video employing adaptive prediction filtering based on a coding unit having a tree structure, according to an exemplary embodiment;

FIG. 8 is a diagram for describing coding units according to an exemplary embodiment;

FIG. 9 is a block diagram of an image encoder based on coding units according to an exemplary embodiment;

FIG. 10 is a block diagram of an image decoder based on coding units according to an exemplary embodiment;

FIG. 11 is a diagram illustrating deeper coding units according to depths and partitions according to an exemplary embodiment;

FIG. 12 is a diagram for describing a relationship between a coding unit and transformation units, according to an exemplary embodiment;

FIG. 13 is a diagram for describing encoding information of coding units corresponding to a coded depth, according to an exemplary embodiment;

FIG. 14 is a diagram of coding units according to depths, according to an exemplary embodiment;

FIGS. 15, 16, and 17 are diagrams for describing a relationship between coding units, prediction units, and transformation units, according to an exemplary embodiment;

FIG. 18 is a diagram for describing a relationship between a coding unit, a prediction unit or a partition, and a transformation unit, according to encoding mode information;

FIG. 19 is a flowchart illustrating a method of encoding a video by using adaptive prediction filtering, according to an exemplary embodiment; and

FIG. 20 is a flowchart illustrating a method of decoding a video by using adaptive prediction filtering, according to an exemplary embodiment.

### DETAILED DESCRIPTION OF EXEMPLARY EMBODIMENTS

Exemplary embodiments will now be described more fully with reference to the accompanying drawings.

Throughout this specification, the term ‘image’ may refer to a moving picture, such as a video, as well as a still image.

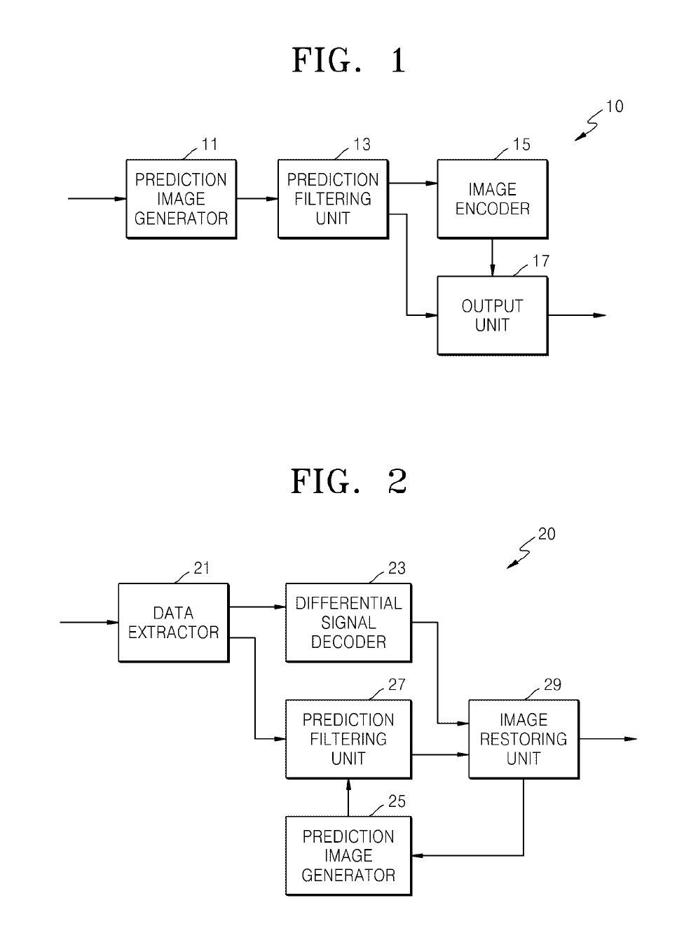

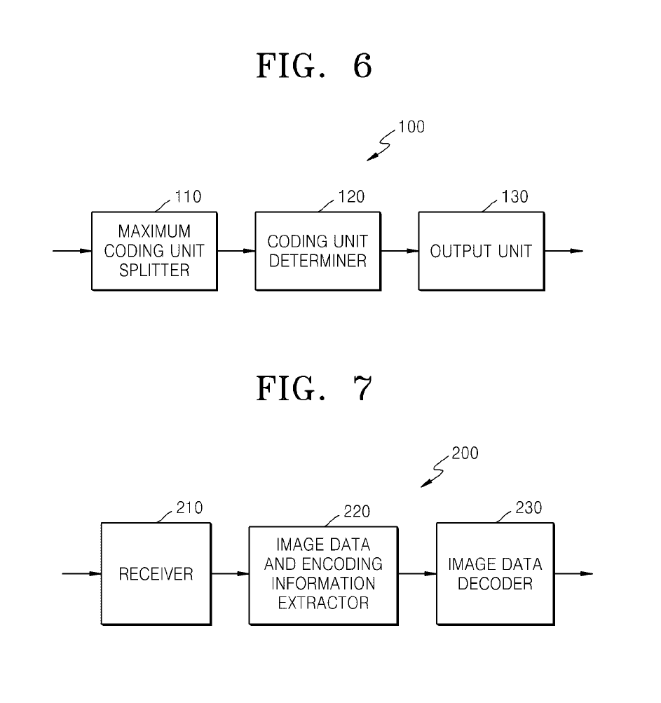

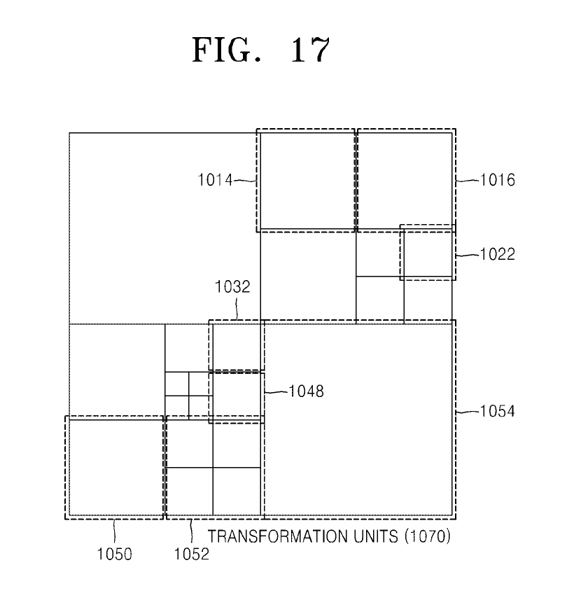

Hereinafter, encoding and decoding of a video by using adaptive prediction filtering according to exemplary embodiments will be described with reference to FIGS. 1 through 5. In addition, encoding and decoding of a video by using adaptive prediction filtering based on a coding unit having a tree structure according to exemplary embodiments will be described with reference to FIGS. 6 through 20.

Hereinafter, apparatuses for encoding and decoding a video by using adaptive prediction filtering, and methods of encoding and decoding a video by using adaptive prediction filtering according to exemplary embodiments will be described with reference to FIGS. 1 through 5.

FIG. 1 is a block diagram of a video encoding apparatus 10 that employs adaptive prediction filtering, according to an exemplary embodiment.

The video encoding apparatus 10 employing adaptive prediction filtering includes a prediction image generator 11, a prediction filtering unit 13, an image encoder 15, and an output unit 17. For convenience of description, the video encoding apparatus 10 employing adaptive prediction filtering will be referred to as the ‘video encoding apparatus 10’. The video encoding apparatus 10 receives an image sequence of a video, encodes a differential signal between images of the image sequence, and encodes and outputs encoding mode information including information about an encoding method.

The prediction image generator 11 generates a prediction image of an original image to be encoded. Throughout this specification, the term ‘prediction image’ refers to an image to be subtracted from a subsequent image to generate a differential signal between a current image and the subsequent image during prediction encoding between the current image and the subsequent image. The prediction image generator 11 may perform motion compensation or intra prediction on the current image of an input video to generate an initial prediction image. In the prediction encoding, the current image, the subsequent image, a restored image, or the like may be a data unit to be encoded, such as a block, a coding unit, a frame, a picture, a slice, or the like, or alternatively, may be a portion of a frame, a picture, a slice, or the like.

The prediction filtering unit 13 generates a prediction filter for the initial prediction image for determining the prediction image for generating the differential signal with respect to the subsequent image, and applies the prediction filter to the initial prediction image to generate a final prediction image of the original image.

The prediction filtering unit 13 may apply the prediction filter to the initial prediction image to determine the prediction image for maximizing encoding efficiency of the differential signal between the prediction image of the current image and the subsequent image. To achieve this, the prediction filtering unit 13 may adaptively determine the prediction filter according to characteristics of the initial prediction image generated by the prediction image generator 11 and characteristics of the original image, and may apply the prediction filter to the initial prediction image to generate the final prediction image for generating the differential signal with respect to the subsequent image.

The prediction filtering unit 13 may compare prediction images that are formed by filtering the initial prediction image of the current image by using various filters that are adaptively determined according to characteristics of the current image, and may determine the prediction image for obtaining an optimal encoding efficiency as the final prediction image by using Rate-Distortion Optimization. The prediction filtering unit 13 may determine a filter for generating the final prediction image as an adaptive prediction filter for the current image.

For example, the prediction filtering unit 13 may apply prediction filters having at least two sets of filter sizes and filter coefficients to the initial prediction image to perform prediction filtering, and may compare encoding efficiency of prediction images obtained by the prediction filtering with encoding efficiency of the differential signal with respect to the subsequent image to determine the final prediction image for generating the optimal encoding efficiency. As such, the prediction filtering unit 13 may determine a filter size and filter coefficient of the prediction filter for generating the final prediction image.

Similarly, the prediction filtering unit 13 may apply various types of prediction filters, such as a one-dimensional prediction filter, a two-dimensional prediction filter, or the like, to the initial prediction image to perform prediction filtering, compare the encoding efficiency of prediction images obtained by the prediction filtering with the encoding efficiency of the differential signal with respect to the subsequent image to determine a filter type and filter coefficient of the prediction filter for generating the final prediction image.

For example, the prediction filtering unit 13 may compare the encoding efficiency of the differential signal with respect to the subsequent image when prediction filtering is performed on a predetermined data unit of a first prediction image to the encoding efficiency of the differential signal with respect to the subsequent image when prediction filtering is not performed on a predetermined data unit to determine a case having a higher encoding efficiency. According to an exemplary embodiment, the predetermined data unit, on which prediction filtering may be performed, may be a block, a coding unit, a maximum coding unit, a slice, a frame, a picture, an image sequence, or the like.

In addition, for example, the prediction filtering unit 13 may perform prediction filtering on an entire portion, a boundary portion, and an internal region other than the boundary region of a predetermined data unit to determine whether prediction filtering is performed. The prediction filtering unit 13 also may compare encoding efficiencies of the differential signal of prediction images obtained by the prediction filtering performed for each respective region of the predetermined data unit of the initial prediction image with the subsequent image to determine a region having the highest encoding efficiency of the differential signal with respect to the subsequent image.

Similarly, the prediction filtering unit 13 may perform prediction filtering based on at least two types of data units of the initial prediction image, compare an encoding efficiency of the prediction image obtained by the prediction filtering with an encoding efficiency of the differential signal with respect to the subsequent image, and determine a type of a data unit of the prediction filtering for generating the final prediction image. The type of the data unit may be classified according to a size of the data unit, a geometrical shape of the data unit, and the like.

In addition, prediction filtering may be changed according to a prediction mode of the data unit. For example, when a current data unit of the initial prediction image is restored by the prediction image generator 11 performing intra prediction, the prediction filtering unit 13 may determine an adaptive prediction filter for the current data unit by using data that is interpolated using information restored by motion compensation among adjacent data units of the current data unit. That is, since information restored by intra prediction is not used for motion compensation of the subsequent image, the prediction filtering unit 13 may interpolate the information restored by motion compensation among the adjacent data units of the current data unit to determine the prediction filter based on a reconstituted data unit.

The image encoder 15 may generate a differential signal between the subsequent image and the final prediction image of the current image, which is generated by the prediction filtering unit 13, and may transform, quantize and entropy encode the differential signal to encode the differential signal of a video.

The final prediction image output from the prediction filtering unit 13 and the differential signal may be synthesized to generate a restored image. The video encoding apparatus 10 may update the restored image by deblocking filtering and post filtering. The restored image may be updated by performing deblocking filtering on a boundary between data units of the restored image.

In addition, the restored image may be updated by determining a post filter for minimizing the amount of errors between the restored image and the original image and performing post filtering by employing the post filter on the synthesized image.

Deblocking filtering and post filtering may be serially performed on the synthesized image of the final prediction image and the differential signal. That is, the restored image is primarily updated by performing deblocking filtering on the restored image formed by synthesizing the final prediction image and the differential signal, and then a post filter for the restored image may be determined and filtered to again update the restored image.

With reference to the restored image of the current image output by deblocking filtering or post filtering, motion compensation of the subsequent image may be performed.

The output unit 17 outputs the differential signal encoded by the image encoder 15 and also outputs encoded prediction filter information. The encoded differential signal and the encoded prediction filter information may be inserted into the same bitstream or respective separate bitstreams.

According to an exemplary embodiment, the prediction filter information may be encoded to include information required for the prediction filtering unit 13 to determine a prediction filter and information required to perform prediction filtering. For example, the prediction information may include one or more from among prediction filter size information that indicates a filter size of the prediction filter, prediction filter type information that indicates a type and filter coefficient of the prediction filter, information that indicates whether prediction filtering is performed on a predetermined data unit, information that indicates a filtering region of a predetermined data unit, information that indicates whether prediction filtering is performed on a predetermined region of a predetermined data unit, information that indicates a type of a data unit on which prediction filtering is to be performed, and information that indicates a filter coefficient of the prediction filter.

According to an exemplary embodiment, prediction filter information for a corresponding data unit may be set for each respective data unit on which prediction filtering is performed. The output unit 17 may sequentially encode and output the prediction filter information for each respective data unit on which prediction filtering is to be performed. In addition, the output unit 17 may encode and output the prediction filter information according to a hierarchical order of the data unit on which prediction filtering is to be performed, based on a hierarchical tree structure of a data unit.

According to an exemplary embodiment, the prediction filter information may be inserted into a header region of a bitstream into which a corresponding encoded differential signal is inserted. The prediction filter information may also be inserted into a data region of the bitstream to which the encoded differential signal is inserted.

According to an exemplary embodiment, when prediction filter information is set for each respective data unit on which prediction filtering is performed, the prediction filter information may be sequentially inserted into a header region of a bitstream to which data units of the encoded differential signal are inserted, according to an order of data units. In addition, the prediction filter information may also be inserted into a data region of a bitstream, in which the encoded differential signal is stored for each respective data unit.

Thus, the video encoding apparatus 10 employing adaptive prediction filtering may encode differential information between the current image and the subsequent image by using an adaptive prediction filter determined according to characteristics of the prediction image of the current image and characteristics of the subsequent image to maximize prediction encoding efficiency.

In addition, a region and data unit on which prediction filtering is to be performed, as well as a size, a type and a filter coefficient of an adaptive prediction filter may be selectively determined according to temporal characteristics and spatial characteristics of the prediction image and original image. Thus, video encoding efficiency may be increased by performing adaptive prediction filtering on the prediction image and the original image.

Since information required to determine an adaptive prediction filter and information required to perform adaptive prediction filtering are encoded and are transmitted together with encoded image data, a receiver may correctly decode a video by using adaptive prediction filtering.

FIG. 2 is a block diagram of a video decoding apparatus 20 employing adaptive prediction filtering, according to an exemplary embodiment.

The video decoding apparatus 20 employing adaptive prediction filtering includes a data extractor 21, a differential signal decoder 23, a prediction image generator 25, a prediction filtering unit 27, and an image restoring unit 29. For convenience of description, the video decoding apparatus 20 employing adaptive prediction filtering will be referred to as the video decoding apparatus 20. The video decoding apparatus 20 receives a bitstream including encoded video data, and restores and outputs the video data.

The data extractor 21 parses the bitstream received by the video decoding apparatus 20, and extracts prediction filter information and encoded data of a differential signal between a current image and a subsequent image of a video.

The data extractor 21 may sequentially extract the prediction filter information for each respective data unit on which prediction filtering is to be performed. The data extractor 21 may extract the prediction filter information according to an order of the data unit on which prediction filtering is to be performed, based on a hierarchical tree structure of the data unit.

The data extractor 21 may extract the prediction filter information from a header region of a bitstream into which a corresponding encoded differential signal is inserted. In addition, the data extractor 21 may also extract the prediction filter information from a data region of the bitstream, into which the encoded differential signal is inserted.

The data extractor 21 may extract the prediction filter information for each respective data unit on which prediction filtering is to be performed. In this case, the data extractor 21 may sequentially extract the prediction filter information from the header region of the bitstream into which data units of the encoded differential signal are inserted, according to an order of a data unit. In addition, the data extractor 21 may also extract the prediction filter information for each respective data unit together with the encoded differential signal of a corresponding data unit, from a data region of the bitstream in which the encoded differential signal is stored.

The differential signal decoder 23 may entropy decode, inverse quantize and inverse transform the encoded data of the differential signal extracted by the data extractor 21 to decode the differential signal between the current image and the subsequent image.

The prediction image generator 25 may perform motion compensation or intra prediction on a restored image of the current image to generate a prediction image. The video decoding apparatus 20 may synthesize the prediction image and the differential signal that is decoded by the differential signal decoder 23 to generate the restored image.

The prediction filtering unit 27 may constitute a prediction filter for the prediction image, based on the prediction filter information extracted by the data extractor 21, and may apply the prediction filter to the prediction image generated by the prediction image generator 25 to generate a final prediction image to be synthesized with the differential signal to be decoded by the differential signal decoder 23.

For example, the prediction filtering unit 27 may constitute the prediction filter for the prediction image of the current image, based on the prediction filter information.

For example, the prediction filtering unit 27 may constitute a prediction filter having a filter size and a filter coefficient that are determined based on prediction filter size information of the prediction filter information. In addition, a prediction filter having a prediction filter type and a filter coefficient that are determined based on prediction filter type information of the prediction filter information.

For example, the prediction filtering unit 27 may determine whether prediction filtering is performed on a predetermined data unit of an initial prediction image, based on information of the prediction filter information, indicating whether prediction filtering is performed on a predetermined data unit. In this case, the predetermined data unit may be at least one of a coding unit, a maximum encoding unit, a slice, a frame, a picture, an image sequence, and the like.

The prediction filtering unit 27 may determine whether prediction filtering is performed on at least one of an entire portion, a boundary portion and an internal region other than the boundary region of a predetermined data unit, based on information of the prediction filter information, indicating whether prediction filtering is performed on the determined region of a predetermined data unit.

The prediction filtering unit 27 may determine the type of data unit on which prediction filtering is to be performed, based on information of the prediction filter information, indicating the type of data unit on which prediction filtering is to be performed. The type of the data unit may be classified according to a size of the data unit, a geometrical shape of the data unit, and the like.

The prediction filtering unit 27 may apply the prediction filter to the prediction image of the current image to generate the final prediction image to be synthesized with the differential signal between the current image and the subsequent image. For example, the prediction filtering unit 27 may obtain an optimal encoding efficiency of the differential signal with respect to the subsequent image by using the final prediction image generated by applying the prediction filter constituted based on the prediction filter information to the initial prediction image, according to Rate-Distortion Optimization.

When the prediction image generator 25 performs intra prediction on a current data unit of the prediction image, the prediction filtering unit 27 may perform prediction filtering on data that is interpolated using information restored by motion compensation among adjacent data units of the current data unit.

The image restoring unit 29 may synthesize the prediction image generated by the prediction filtering unit 27 and the differential signal between the subsequent image and the current image decoded by the differential signal decoder 23 to restore an original image.

For example, the image restoring unit 29 may synthesize the final prediction image of the current image, generated by using prediction filtering, and the differential signal between the current image and the subsequent image to restore the subsequent image.

Similarly, the image restoring unit 29 may generate a restored image of the subsequent image and a restored image of the current image. In this case, the prediction image generator 25 may perform motion compensation on the restored image of the current image with reference to a restored image of a previous image, or may perform intra prediction on the restored image of the current image to generate a prediction image of the previous image. The differential signal decoder 23 may entropy decode, inverse quantize and inverse transform the extracted encoded differential signal to decode the differential signal between a decoded previous image and the current image. The image restoring unit 29 may synthesize the prediction image of the previous image and the differential signal between the previous image and the current image to generate a restored image of the current image. The prediction image generator 25 may perform motion compensation or intra prediction on the restored image of the current image to generate an initial prediction image of the current image. The initial prediction image may be updated to a final prediction image by using prediction filtering.

The image restoring unit 29 may generate a restored image formed by synthesizing the final prediction image and the differential signal, and may perform deblocking filtering and post filtering on the restored image to update the restored image. That is, the image restoring unit 29 may perform deblocking filtering on a boundary between data units of the restored image to update a restored image of the subsequent image.

In addition, the image restoring unit 29 may determine a post filter for minimizing the amount of errors between the restored image and the original image, and may perform post filtering on the restored image to update the restored image. For motion compensation of the subsequent image, reference may be made to the restored image that is updated by deblocking filtering or post filtering.

For example, deblocking filtering may be further performed on the restored image formed by synthesizing the prediction image of the previous image and the differential signal between the previous image and the current image to update the restored image of the current image. In addition, the post filter for minimizing the amount of errors between the restored image of the current image and the original image may be applied to the restored image of the current image to update the restored image of the current image. Reference may be made to the restored image of the current image, which is updated by using deblocking or post filtering, for motion compensation of the subsequent image. Similarly, reference may be made to the restored image of the subsequent image, which is updated by using deblocking or post filtering, for motion compensation of a next subsequent image of the subsequent image.

Information related to a loop filter for a subsequent process, such as deblocking filtering, post filtering, or the like, may be encoded and may be transmitted together with encoded image data. Thus, the loop filter for a subsequent process, such as deblocking filtering, post filtering, or the like, is constituted based on the information related to the loop filter for the subsequent process, and then the corresponding subsequent process is performed using the loop filter.

The video decoding apparatus 20 receives a bitstream encoded by using adaptive prediction filtering to maximize encoding efficiency based on motion prediction, and receives the prediction filter information transmitted together with the encoded video data. Since the prediction filter for adaptive prediction filtering may be correctly constituted based on the received prediction filter information, the decoded differential signal and the prediction image generated by performing prediction filtering on the prediction image of the restored image by the prediction image are synthesized to restore the subsequent image to thus correctly restore an image sequence of a video.

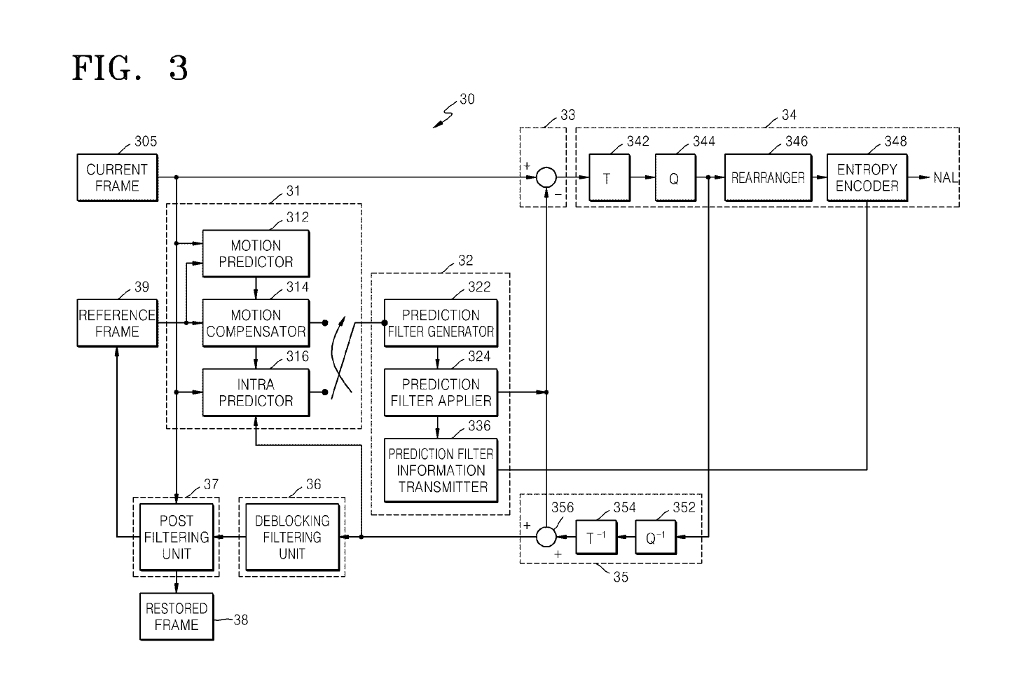

FIG. 3 is a detailed block diagram of a video encoding apparatus 30 employing adaptive prediction filtering, according to an exemplary embodiment.

The video encoding apparatus 30 employing adaptive prediction filtering includes a predictor 31, a prediction filter 32, a differential signal encoder 34, a restored image generator 35, a deblocking filtering unit 36, and a post filtering unit 37. The video encoding apparatus 30 employing adaptive prediction filtering may correspond to the video encoding apparatus 10 described with reference to FIG. 1.

The predictor 31 performs prediction encoding on a video through a motion predictor 312, a motion compensator 314, and an intra predictor 316. The motion predictor 312 predicts motion information between images of the video. For example, the motion predictor 312 may predict motion information between a current frame 305 and a reference frame 39 of a previous frame. The motion compensator 314 performs motion compensation on the reference frame 39, based on the motion information predicted by the motion predictor 312. When a current data unit is an intra mode, the intra predictor 316 predicts the current data unit by using adjacent data of the current data unit of the same frame.

The predictor 31 may correspond to the prediction image generator 11 of the video encoding apparatus 10. The predictor 31 may generate an initial prediction image for generating a differential signal to be encoded by the differential signal encoder 34. That is, the image on which motion compensation is performed by the motion compensator 314 of the predictor 31, and the image on which intra prediction is performed by the intra predictor 316 may each be the initial prediction image.

The prediction filter 32 may determine a prediction filter, and may generate a final prediction image from the initial prediction image. A prediction filter generator 322 determines a prediction filter for generating the final prediction image from the initial prediction image. A prediction filter applier 324 applies the prediction filter determined by the prediction filter generator 322 to the initial prediction image to output the final prediction image. That is, the prediction filter generator 322 and the prediction filter applier 324 may correspond to the prediction filtering unit 13 of the video encoding apparatus 10. Thus, the prediction filter generator 322 may determine filter characteristics, a filtering method, and the like. In other words, the prediction filter generator 322 may determine a filter size of the prediction filter, a shape of the prediction filter, a filter coefficient, a data unit on which prediction filtering is to be performed, the type of data unit, whether prediction filtering is performed on a predetermined data unit, a filtering region of the predetermined data unit, and whether prediction filtering is performed on a predetermined region of the predetermined data unit.

A prediction filter information transmitter 336 may output information about components of the prediction filter determined by the prediction filter generator 322, and prediction filter information including information about the prediction filtering performed by the prediction filter applier 324.

A subtractor 33 generates a differential signal between the current frame 305 and the final prediction image output from the prediction filter applier 324. The differential signal may be encoded and output through a transformer (T) 342, a quantizer (Q) 344, a rearranger 346, and an entropy encoder 348. Data symbols including the prediction filter information output from the prediction filter information transmitter 336, as well as the image data and encoding information, which are encoded by the entropy encoder 348, may be output in a datastream having a unit of a Network Adaptive Layer (NAL). Thus, the prediction filter information transmitter 336 and the differential signal encoder 34 may correspond to the image encoder 15 and the output unit 17 of the video encoding apparatus 10, respectively.

The restored image generator 35 may synthesize the differential signal and the final prediction image to generate a restored image. A transformation coefficient of the differential signal, which is quantized by the transformer 342 and the quantizer 344, is restored to a differential signal of a spatial region by an inverse quantizer (Q⁻¹) 352 and an inverse transformer 354 (T⁻¹). The restored differential signal is synthesized with the final prediction image generated by the prediction filter applier 324 through an adder 356 to generate a restored image.

A deblocking filtering unit 36 performs deblocking filtering on the restored image to reduce a block phenomenon at a boundary between blocks of the restored image and thus update the restored image. The post filtering unit 37 may perform post filtering for minimizing the amount of errors with an original image on the restored image to update the restored image. The restored image output from the post filtering unit 37 may be finally output to a restored frame 38 and may be used as the reference frame 39 that is used for the motion compensator 314 to perform motion compensation.

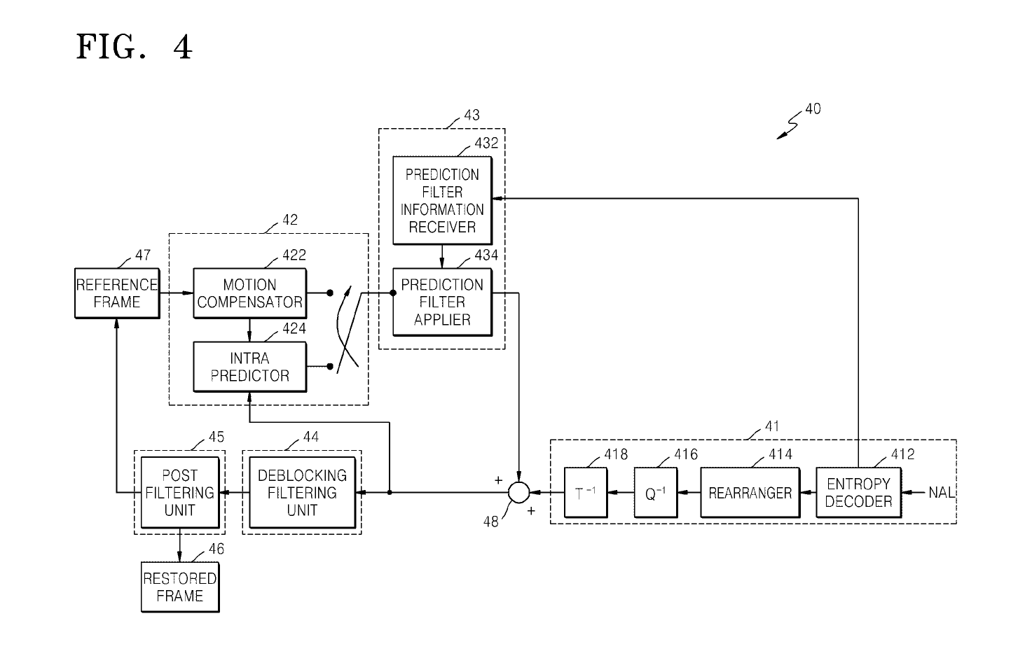

FIG. 4 is a detailed block diagram of a video decoding apparatus 40 employing adaptive prediction filtering, according to an exemplary embodiment.

The video decoding apparatus 40 employing adaptive prediction filtering includes a decoder 41, a prediction image restoring unit 42, a prediction filter 43, a deblocking filtering unit 44, and a post filtering unit 45. The video decoding apparatus 40 employing adaptive prediction filtering may correspond to the video decoding apparatus 20 described with reference to FIG. 2.

The decoder 41 may receive a video data stream having a unit of NAL. The decoder 41 may parse the received video data stream and extract encoded image data, encoding information, and prediction filter information from the parsed video stream. The encoded image data is restored to a transformation coefficient quantized by an entropy decoder 412 and a rearranger 414. The quantized transformation coefficient may be restored to a differential signal of a spatial region through an inverse quantizer 416 and an inverse transformer 418, and may be output. The decoder 41 may correspond to the data extractor 21 and the differential signal decoder 23 of the video decoding apparatus 20.

The prediction image restoring unit 42 may perform prediction decoding of a video through a motion compensator 422 and an intra predictor 424. The motion compensator 422 performs motion compensation on a reference frame 47, based on the received encoding information. When a current data unit is an intra mode, the intra predictor 424 may restore the current data unit by using adjacent data of the current data unit of the same frame. The prediction image restoring unit 42 may correspond to the prediction image generator 25 of the video decoding apparatus 20. The prediction image restoring unit 42 may generate an initial prediction image to be synthesized with a differential signal restored by the decoder 41. That is, the image on which motion compensation is performed by the motion compensator 422 of the prediction image restoring unit 42, and the image on which intra prediction is performed by the intra predictor 424 may each be the initial prediction image.

The prediction filter 43 may generate a final prediction image from the initial prediction image, and may include a prediction filter information receiver 432 and a prediction filter applier 434, which may correspond to the prediction filtering unit 27 of the video decoding apparatus 20. The prediction filter information receiver 432 may receive prediction filter information extracted from the received video data stream, and may transmit the prediction filter information, including information about components of the prediction filter and information about prediction filtering, to the prediction filter applier 434.

The prediction filter applier 434 may receive the information about components of the prediction filter, that is, information about a filter size of the prediction filter, a shape of the prediction filter and a filter coefficient, the information about prediction filtering, that is, information about a data unit on which prediction filtering is to be performed, the type of data unit, whether prediction filtering is performed on a predetermined data unit, a filtering region of the predetermined data unit and whether prediction filtering is performed on a predetermined region of the predetermined data unit, and the like. The prediction filter applier 434 may constitute the prediction filter, based on the information about components of the prediction filter, and may perform filtering in which the prediction filter is applied to the initial prediction image to output the final prediction image.

The differential signal restored by the decoder 41 and the final prediction image output from the prediction filter applier 434 may be synthesized to generate a restored image. The deblocking filtering unit 44 may perform deblocking filtering on the restored image, and the post filtering unit 45 may perform post filtering on the restored image to reduce the amount of errors between the restored image and an original image. The restored image output from the post filtering unit 45 may be finally output to a restored frame 46, or may be used as the reference frame 47 that is used for the motion compensator 422 to perform motion compensation.

In detail, the motion compensator 422 may perform motion compensation for the current frame with reference to the reference frame 47 of a previous image, and the intra predictor 424 may predict a differential signal between adjacent regions of the current frame to generate a prediction image of the current frame.

The prediction image of the current frame may be updated to the final prediction image by performing prediction filtering by the prediction filter applier 434. The differential signal between the current frame and a subsequent frame, which is restored by the decoder 41, and the final prediction image of the current frame may be synthesized to generate an initial restored image of the subsequent frame.

The initial restored image of the subsequent frame may be updated and output through the deblocking filtering unit 44 and the post filtering unit 45. The output restored image of the subsequent frame may be output as the restored frame 46 of the subsequent frame, and may be used as the reference frame 47 when motion compensation is performed on a next subsequent frame of the subsequent frame.

The video encoding apparatus 30 of FIG. 3 and the video decoding apparatus 40 of FIG. 4 perform both deblocking filtering and post filtering on the restored image, but the exemplary embodiments are not limited thereto. Thus, the video encoding apparatus 10 and the video decoding apparatus 20 may perform at least one of deblocking filtering and post filtering and may perform a subsequent process. Alternatively, the video encoding apparatus 10 and the video decoding apparatus 20 may not perform the subsequent process of deblocking filtering and post filtering and may generate a restored image.

Since a loop filter, such as a deblocking filter, a post filter, and the like, generates a filter during an encoding process and applies the generated filter to a restored image, image quality of a restored image may be improved at the same bitrate, but an amount of data of the encoded differential signal to be output as a result of the encoding is not reduced.

On the other hand, according to an exemplary embodiment, a prediction filter that is a loop filter for prediction encoding, constitutes one prediction image from prediction data generated by motion prediction/compensation, and generates an adaptive filter coefficient for minimizing the amount of errors between a prediction image and an original image. In addition, when the prediction image is filtered by using the generated prediction filter coefficient, the amount of errors between the prediction image and the original image is minimized. Thus, when a differential signal between the prediction image and the original image is encoded, a smallest possible amount of data may be encoded and transmitted, and thus encoding efficiency may be maximized.

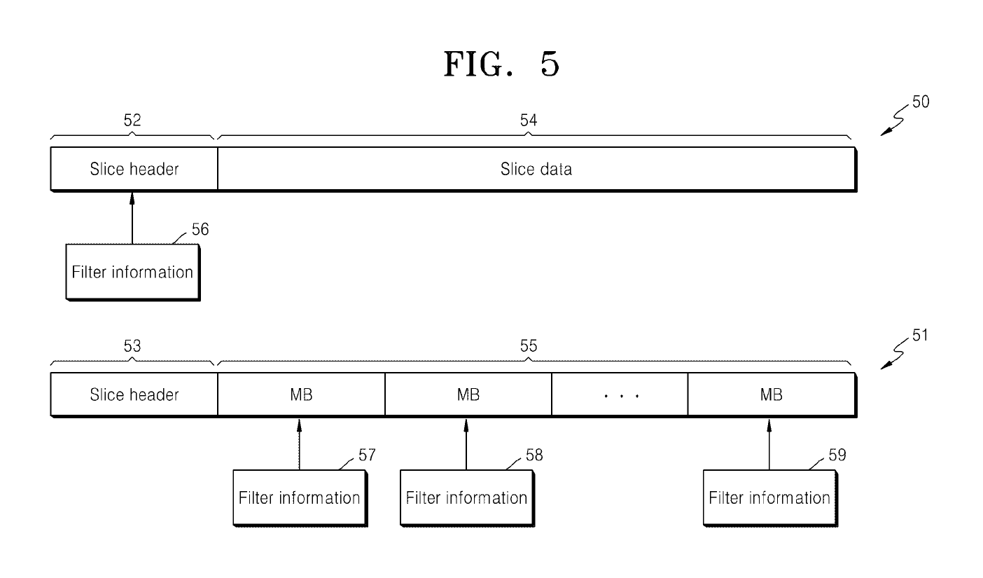

FIG. 5 is a diagram of a structure of a bitstream including prediction filter information about adaptive prediction filtering, according to an exemplary embodiment.

The output unit 17 of the video encoding apparatus 10 may output the encoded differential signal of a video and the prediction filter information to bitstreams 50 and 51. The output unit 17 of the video encoding apparatus 10 may insert encoded image data in a slice unit to data regions 54 and 55 of the bitstreams 50 and 51, and may insert any information related to slice data to the slice header regions 52 and 53.

The output unit 17 may set prediction filter information 56 corresponding to the encoded differential signal that is inserted into a data region 54 of a bitstream 50. In this case, the prediction filter information 56 may be inserted into the slice header region 52.

The output unit 17 may separately set prediction filter information for a corresponding data unit, for each respective data unit on which prediction filtering is performed. For example, when the encoded differential signal is inserted in units of macroblocks MBs into a data region 55 of the bitstream 50, corresponding prediction filter information 57, 58 and 59 may be set for respective macroblocks MBs of the differential signal.

The output unit 17 may sequentially encode the prediction filter information 57, 58 and 59 according to a data unit to insert the prediction filter information 57, 58 and 59 into the slice header region 53. The prediction filter information 57, 58 and 59 may be inserted into the data region 55 of a bitstream 51, together with the differential signal encoded for each respective corresponding macroblock.

When the differential signal is encoded according to a hierarchical tree structure, the output unit 17 may encode the prediction filter information 57, 58 and 59 according to a hierarchical order of a data unit on which prediction filtering is to be performed, and may insert the prediction filter information 57, 58 and 59 into the slice header region 53.

The data extractor 21 of the video decoding apparatus 20 receives and parses the bitstreams 50 and 51 and extracts encoded data of the differential signal and the prediction filter information from the parsed bitstreams. The encoded differential signal may be extracted in slice units in the data regions 54 and 55 of the bitstreams 50 and 51.

The data extractor 21 may extract the prediction filter information 56 about the encoded slice data of the differential signal from the slice header region 52 of the bitstream 50.

The data extractor 21 may separately extract corresponding prediction filter information that is set for each respective data unit on which prediction filtering is to be performed. For example, the prediction filter information 57, 58 and 59 may be separately extracted for each respective macroblock on which prediction filtering is to be performed.

In this case, the data extractor 21 may sequentially extract the prediction filter information 57, 58 and 59 from the slice header region 53 of the bitstream 51 according to an order of a macroblock. The data extractor 21 may extract the prediction filter information 57, 58 and 59 for each respective macroblock unit of the encoded differential signal of the data region 55 of the bitstream 51, together with the encoded differential signal of the prediction filter information 57, 58 and 59.

When the differential signal to be extracted from the data regions 54 and 55 is encoded according to a hierarchical tree structure, the data extractor 21 may extract the prediction filter information from the bitstreams 50 and 51 according to a hierarchical order of a data unit on which prediction filtering is to be performed.

Hereinafter, apparatuses for encoding and decoding a video and methods of encoding and decoding a video, for performing adaptive prediction filtering based a coding unit according to a tree structure according to exemplary embodiments will be described with reference to FIGS. 6 through 20.

FIG. 6 is a block diagram of a video encoding apparatus 100 employing adaptive prediction filtering based on a coding unit having a tree structure according to an exemplary embodiment. The video encoding apparatus 100 includes a maximum coding unit splitter 110, a coding unit determiner 120, and an output unit 130.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an exemplary embodiment may be characterized by a maximum size and a depth. The depth denotes a number of times the coding unit is spatially split from the maximum coding unit. As the depth deepens, deeper encoding units according to depths may be split from the maximum coding unit to a minimum coding unit. A depth of the maximum coding unit is an uppermost depth, and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. Thus, the encoded image data of the coding unit corresponding to the determined coded depth is output. Also, the coding units corresponding to the coded depth may be regarded as encoded coding units.

The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the amount of coding units increases. Also, even if coding units correspond to same depth in one maximum coding unit, it is determined whether to split each of the coding units corresponding to the same depth to a lower depth by measuring an encoding error of the image data of the each coding unit, separately. Accordingly, even when image data is included in one maximum coding unit, the image data is split to regions according to the depths and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of splits from a maximum coding unit to a minimum coding unit. A maximum depth according to an exemplary embodiment may denote the total number of splits from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the maximum depth may be set to 4.

Prediction encoding and transformation may be performed according to the maximum coding unit. The prediction encoding and the transformation are also performed based on the deeper coding units according to a depth equal to or depths less than the maximum depth, according to the maximum coding unit. Transformation may be performed according to method of orthogonal transformation or integer transformation.

Since the amount of deeper coding units increases whenever the maximum coding unit is split according to depths, encoding including the prediction encoding and the transformation is performed on all of the deeper coding units generated as the depth deepens. For convenience of description, the prediction encoding and the transformation will now be described based on a coding unit of a current depth, in a maximum coding unit.

The video encoding apparatus 100 may select a size or shape of a data unit for encoding the image data. In order to encode the image data, operations, such as prediction encoding, transformation, and entropy encoding, are performed. At this time, the same data unit may be used for all operations or different data units may be used for each operation.

For example, the video encoding apparatus 100 may select, not only a coding unit for encoding the image data, but also a data unit different from the coding unit to perform the prediction encoding on the image data in the coding unit.

In order to perform prediction encoding in the maximum coding unit, the prediction encoding may be performed based on a coding unit corresponding to a coded depth, i.e., based on a coding unit that is no longer split to coding units corresponding to a lower depth. Hereinafter, the coding unit that is no longer split, and becomes a basis unit for prediction encoding, will now be referred to as a ‘prediction unit’. A partition obtained by splitting the prediction unit may include a prediction unit or a data unit obtained by splitting at least one of a height and a width of the prediction unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based, not only on the coding unit for encoding the image data, but also based on a data unit that is different from the coding unit.

In order to perform the transformation in the coding unit, the transformation may be performed based on a data unit having a size smaller than or equal to the size of coding unit. For example, the data unit for the transformation may include a data unit for an intra mode and a data unit for an inter mode.

A data unit used as a base of the transformation will now be referred to as a ‘transformation unit’. A transformation depth indicating the number of splits to reach the transformation unit by splitting the height and width of the coding unit may also be set in the transformation unit. For example, in a current coding unit of 2N×2N, a transformation depth may be 0 when the size of a transformation unit is also 2N×2N. Also, the transformation depth may be 1 when each of the height and width of the current coding unit is split into two equal parts, totally split into 4̂1 transformation units, and the size of the transformation unit is thus N×N. Alternatively, the transformation depth may be 2 when each of the height and width of the current coding unit is split into four equal parts, totally split into 4̂2 transformation units and the size of the transformation unit is thus N/2×N/2. For example, the transformation unit may be set according to a hierarchical tree structure, in which a transformation unit of an upper transformation depth is split into four transformation units of a lower transformation depth according to the hierarchical characteristics of a transformation depth.

Similar to the coding unit, the transformation unit in the coding unit may be recursively split into smaller sized regions, so that the transformation unit may be determined independently in units of regions. Thus, residual data in the coding unit may be divided according to the transformation having the tree structure according to transformation depths.

Encoding information according to coding units corresponding to a coded depth requires not only information about the coded depth, but also information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

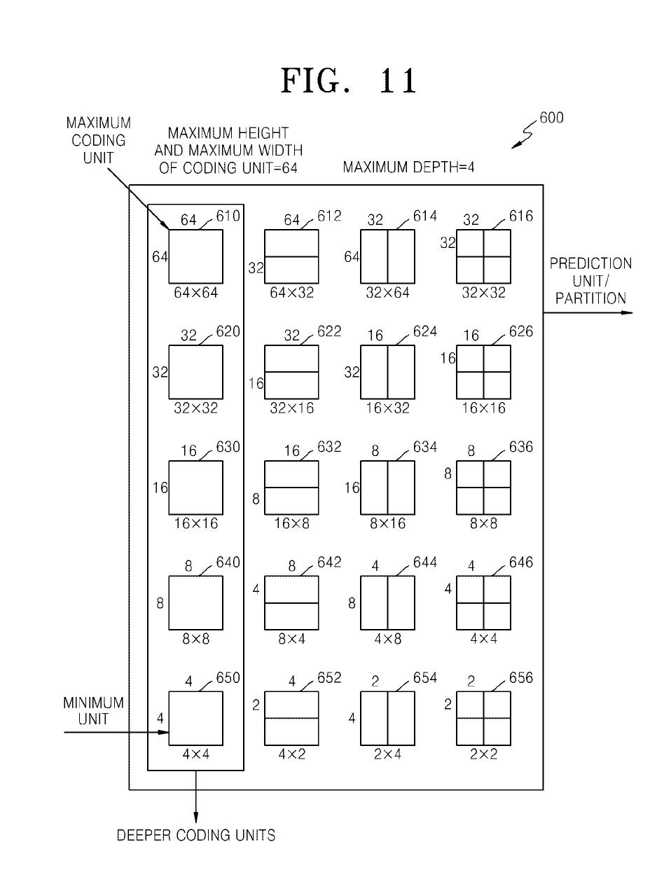

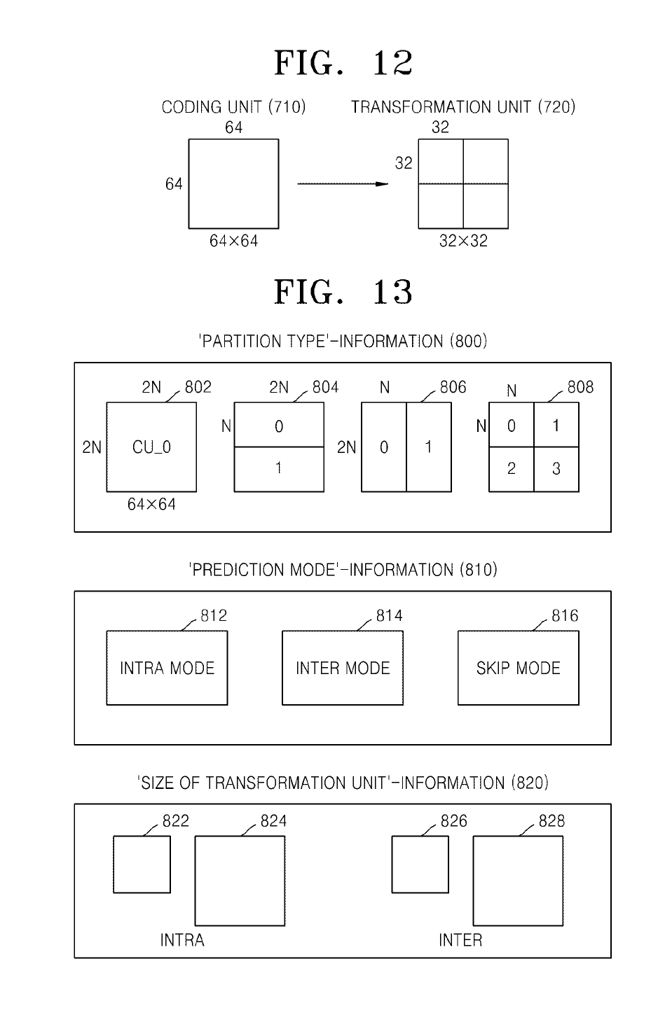

Coding units according to a tree structure in a maximum coding unit and a method of determining a partition, according to exemplary embodiments, will be described in detail with reference to FIGS. 11 and 12.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an exemplary embodiment is a rectangular data unit obtained by splitting the minimum coding unit constituting the lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include one or more of information about an estimated direction of an inter mode, information about a reference image index of the inter mode, information about a motion vector, information about a chroma component of an intra mode, and information about an interpolation method of the intra mode. Also, information about a maximum size of the coding unit defined according to pictures, slices, or GOPs, and information about a maximum depth may be inserted into SPS (Sequence Parameter Set) or a header of a bitstream. In addition, the encoding information output through the output unit 130 may include the prediction filter coefficient information according to exemplary embodiments have been described with reference to FIGS. 1 through 5.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include maximum 4 of the coding unit of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

The video encoding apparatus 100 may further perform a loop filtering process for performing prediction filtering according to a coding unit based on a hierarchical tree structure according to an exemplary embodiment.

The output unit 130 may further include the prediction filtering unit 13 of the video encoding apparatus 10. In this case, the prediction filtering unit 13 may determine a prediction filter for a prediction image generated based on the coding unit determined by the coding unit determiner 120, a prediction unit, and motion compensation based on a partition. The output unit 130 may transform and quantize a differential signal between a subsequent image and a final prediction image generated by prediction filtering, based on the coding unit determined by the coding unit determiner 120 and a transformation unit and may entropy encode the differential signal to output encoding differential data of a video.

As described above, the output unit 130 may encode and output the prediction filter information about prediction filtering and the prediction filter determined based on the coding unit according to a hierarchical tree structure. Thus, in this case, the video encoding apparatus 100 employing adaptive prediction filtering based on the coding unit according to a tree structure may encode a differential signal between continuous images just before an encoding result is obtained based on the coding unit according to the tree structure after prediction filtering is performed, thereby improving encoding efficiency.

In this case, the prediction filtering unit 13 may select a data unit on which prediction filtering is to be performed as one of the coding unit determined by the coding unit determiner 120, a prediction unit and a partition. In this case, the output unit 130 may not include a separate data unit in the prediction filter information.

In order to determine a data unit on which prediction filtering is to be performed, the prediction filtering unit 13 may determine a filtering data unit of a prediction filter for maximizing encoding efficiency of a differential signal between a prediction image and a subsequent image, regardless of the coding unit determined by the coding unit determiner 120, the prediction unit or the partition. In this case, the output unit 130 may separately set a filtering data unit according to the prediction filter information and may output the filtering data unit.

The coding unit determiner 120 may further include the prediction filtering unit 13 of the video encoding apparatus 10. In this case, when the coding unit determiner 120 selects a coded depth for generating maximum encoding efficiency and determines a coding unit of a tree structure according to an exemplary embodiment while recursively performing encoding according to coding units according to depths and available prediction units (or partitions), the prediction filtering unit 13 may perform prediction filtering in order to obtain a prediction image generated by motion compensation.

That is, the coding unit determiner 120 may recursively determine a prediction filter and a prediction filtering method as well as a coding unit, a prediction unit (partition) and a prediction mode having the highest encoding efficiency by repeatedly determining a prediction filter for generating a prediction image for minimizing a differential signal between a subsequent image and an initial prediction image generated by motion prediction and motion compensation for each of respective coding units according to depths and available prediction unit (or partition), and performing motion prediction and motion compensation with reference to a restored image generated by the prediction filtering.

The output unit 130 may output image data that is encoded by a coding unit according to a tree structure determined by the coding unit determiner 120, an encoding unit, a prediction filter and a prediction filtering method, and may output encoding mode information and prediction filter information.

Accordingly, the video encoding apparatus 100 employing adaptive prediction filtering based on a coding unit according to a tree structure according to an exemplary embodiment may determine a coding unit, an encoding mode and information about a prediction filter, for maximizing an encoding efficiency according to image characteristics by recursively determining a component of a prediction filter and a filtering method together with a coding unit according to a tree structure and a prediction mode.

In general, if an image having a high resolution or a large amount of data is encoded in a conventional macroblock, the amount of macroblocks per picture excessively increases. Accordingly, the amount of pieces of compressed information generated for each macroblock increases, and thus it is difficult to transmit the compressed information and data compression efficiency decreases. However, by using the video encoding apparatus 100, image compression efficiency may be increased since a coding unit and a coding method are adjusted while considering characteristics of an image while increasing a maximum size of a coding unit while considering the size of the image.

FIG. 7 is a block diagram of a video decoding apparatus 200 employing adaptive prediction filtering based on a coding unit having a tree structure, according to an exemplary embodiment. The video decoding apparatus 200 includes a receiver 210, an image data and encoding information extractor 220, and an image data decoder 230. Various terms, such as a coding unit, a depth, a prediction unit, a transformation unit, and information about various encoding modes, for various operations of the video decoding apparatus 200 are identical to those described with reference to FIG. 6 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture from a header about the current picture or SPS.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, information about a prediction mode, and a size of a transformation unit. Splitting information according to depths may be extracted as the information about the coded depth. In addition, the prediction filter information described with reference to FIGS. 1 through 5 may be extracted as information about an encoding mode.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include a prediction including intra prediction and motion compensation, and an inverse transformation. Inverse transformation may be performed according to method of inverse orthogonal transformation or inverse integer transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse transformation according to each transformation unit in the coding unit, based on the information about the size of the transformation unit of the coding unit according to coded depths, to perform the inverse transformation according to maximum coding units.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to the each coded depth in the current maximum coding unit by using the information about the partition type of the prediction unit, the prediction mode, and the size of the transformation unit for each coding unit corresponding to the coded depth, and output the image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded.

The video decoding apparatus 200 may further perform prediction filtering for minimizing the amount of errors between an original image and a prediction image generated by motion compensation. The image data and encoding information extractor 220 may extract prediction filter information as well as encoded image data and encoding mode information about coding units according to a maximum encoding unit, from a parsed bitstream.

The image data decoder 230 may perform operations of the differential signal decoder 23, the prediction image generator 25, the prediction filtering unit 27 and the image restoring unit 29 of the video decoding apparatus 20, and may perform decoding operations of encoding image data about coding units according to a tree structure for each respective maximum coding unit and image data based on encoding mode information.

That is, the image data decoder 230 may constitute a prediction filter for a prediction image on which motion compensation is performed based on a coding unit of an encoded depth and a prediction unit (or partition), based on the prediction filter information. The image data decoder 230 may synthesize a differential signal that is restored by entropy decoding, inverse quantizing and inverse transforming image data extracted from a received bitstream with a final prediction image generated by prediction filtering to generate a restored image.

In this case, when the image data decoder 230 constitutes the prediction filter and performs prediction filtering, a data unit for prediction filtering may be a coding unit according to a tree structure according to the received encoding mode information or a prediction unit. In this case, the image data decoder 230 may perform inverse quantizing, inverse transformation, intra prediction, motion compensation and prediction filtering according to a coding unit according to a tree structure and an encoding mode to decode encoded image data and to generate a restored image.

Alternatively, when the image data decoder 230 constitutes the prediction filter and performs prediction filtering, a data unit for prediction filtering may be a data unit determined according to prediction filter information, regardless of a coding unit according to a tree structure according to the received encoding mode information or a prediction unit. In this case, the image data decoder 230 may generate a final prediction image by constituting a prediction filter according to the prediction filter information about the prediction image generated by motion compensation and applying the prediction filter to a filtering data unit determined according to the prediction filter information, and may generate a restored image by synthesizing the final prediction image with the decoded differential signal.

Accordingly, even if image data has a high resolution, and thus there exists a large amount of data, the image data may be efficiently decoded and restored by using the size of a coding unit, an encoding mode, a prediction filter, and a prediction filtering method, which are adaptively determined according to characteristics of the image data, by using information about an optimum encoding mode received from an encoder.

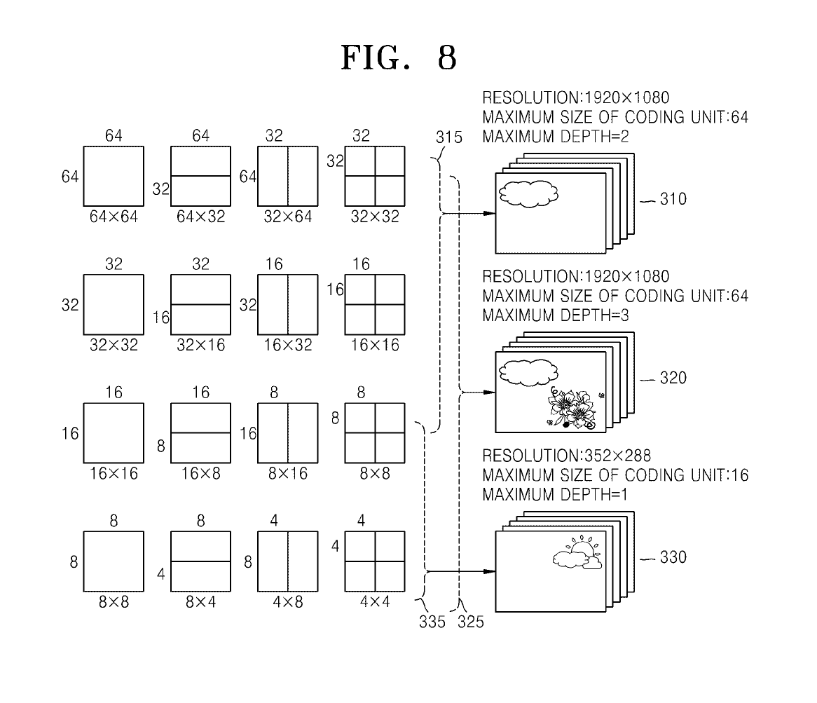

A method of determining coding units having a tree structure, a prediction unit, and a transformation unit, according to an exemplary embodiment, will now be described with reference to FIGS. 8 through 18.

FIG. 8 is a diagram for describing a concept of coding units according to an exemplary embodiment.

A size of a coding unit may be expressed in width by height, and may be 64×64, 32×32, 16×16, and 8×8. A coding unit of 64×64 may be split into partitions of 64×64, 64×32, 32×64, or 32×32. A coding unit of 32×32 may be split into partitions of 32×32, 32×16, 16×32, or 16×16. A coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 8 denotes a total number of splits from a maximum coding unit to a minimum coding unit.

If a resolution is high or a data amount is large, a maximum size of a coding unit may be large, to not only increase encoding efficiency, but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

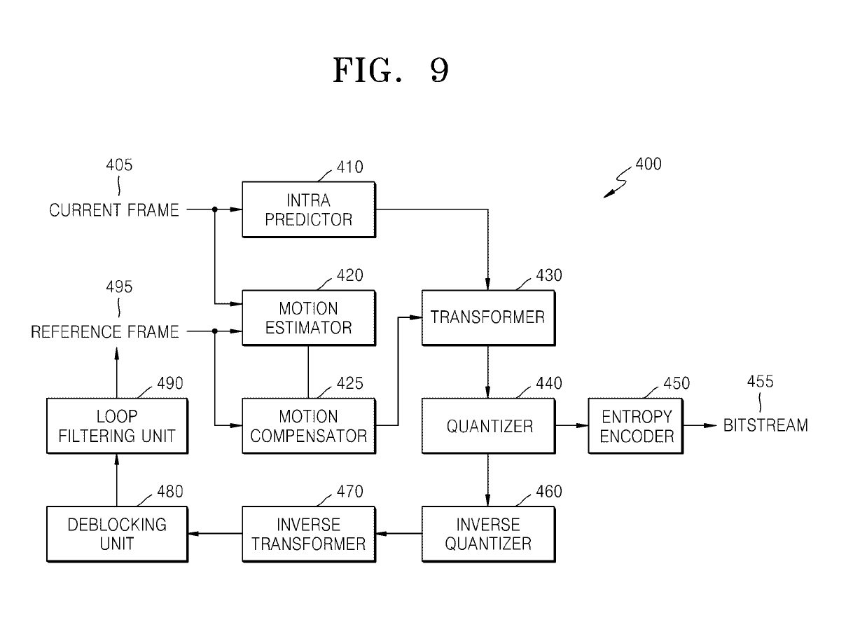

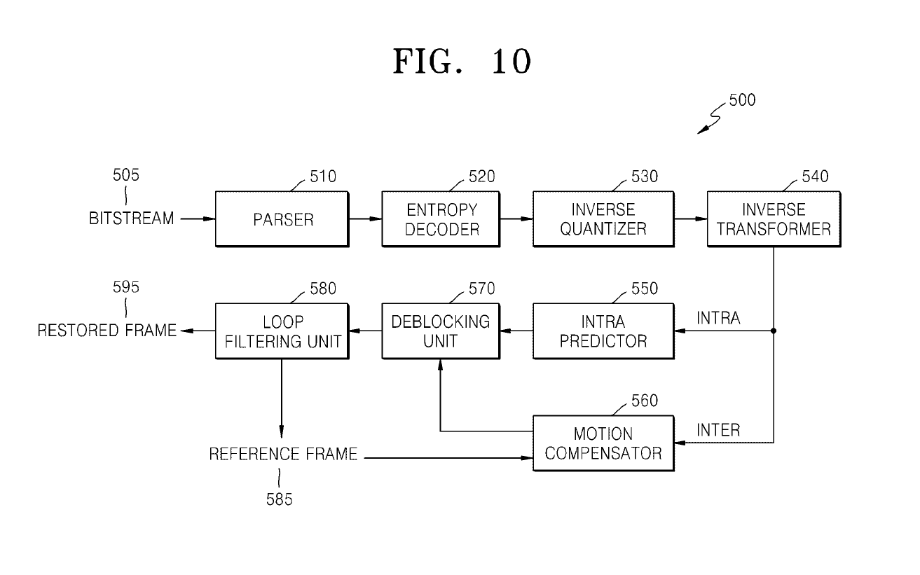

FIG. 9 is a block diagram of an image encoder 400 based on coding units, according to an exemplary embodiment. The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 performs inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determine partitions and a prediction mode of each coding unit from among the coding units having a tree structure, while considering the maximum size and the maximum depth of a current maximum coding unit. The transformer 430 determines the size of the transformation unit in each coding unit from among the coding units having a tree structure.

FIG. 10 is a block diagram of an image decoder 500 based on coding units, according to an exemplary embodiment. A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data that is post-processed through the deblocking unit 570 and the loop filtering unit 580 may be output as the reference frame 585.

In order to decode the image data in the image data decoder 230 of the video decoding apparatus 200, the image decoder 500 may perform operations that are performed after the parser 510.

In order for the image decoder 500 to be applied in the video decoding apparatus 200, elements of the image decoder 500, i.e., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure for each maximum coding unit.

Specifically, the intra prediction 550 and the motion compensator 560 perform operations based on partitions and a prediction mode for each of the coding units having a tree structure, and the inverse transformer 540 perform operations based on a size of a transformation unit for each coding unit.

FIG. 11 is a diagram illustrating deeper coding units according to depths, and partitions, according to an exemplary embodiment. The video encoding apparatus 100 and the video decoding apparatus 200 use hierarchical coding units to consider characteristics of an image. A maximum height, a maximum width, and a maximum depth of coding units may be adaptively determined according to the characteristics of the image, or may be set according to an input of a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 4. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is assigned to a partition having a size of 4×4. In addition, a prediction unit of the coding unit 650 having the size 4×4 may include partitions 654 having the size 4×2, partitions 654 having the size 2×4, and partitions 656 having the size 2×2.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A amount of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

FIG. 12 is a diagram for describing a relationship between a coding unit 710 and transformation units 720, according to an exemplary embodiment. The video encoding apparatus 100 or 200 encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 13 is a diagram for describing encoding information of coding units corresponding to a coded depth, according to an exemplary embodiment. The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800, 810, and 820 for decoding, according to each deeper coding unit.

Although not illustrated in FIG. 13, prediction filter information as well as the information 800 about a partition type, the information 810 about a prediction mode, and the information 820 about the size of a transformation unit may be encoded and transmitted for each coding unit of an encoded depth. According to an exemplary embodiment, the prediction filter information may be set for each data unit on which prediction filtering is performed, or for each data unit.

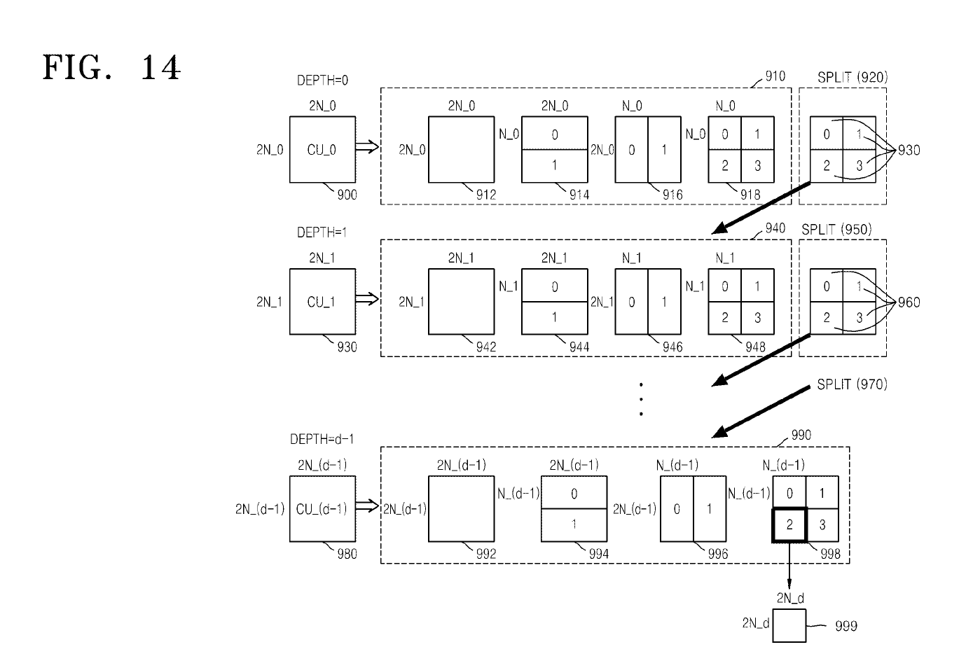

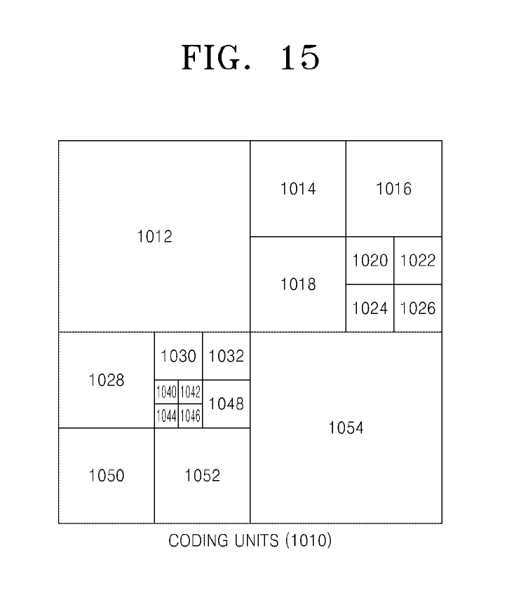

FIG. 14 is a diagram of deeper coding units according to depths, according to an exemplary embodiment. Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 14 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

Errors of encoding including the prediction encoding in the partition types 912 through 918 are compared, and the least encoding error is determined among the partition types. If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Also, since the maximum depth is d and a minimum coding unit 980 having a lowermost depth of d−1 is no longer split to a lower depth, split information for the minimum coding unit 980 is not set.

A data unit 999 may be a ‘minimum unit’ for the current maximum coding unit. A minimum unit according to an embodiment of the present invention may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

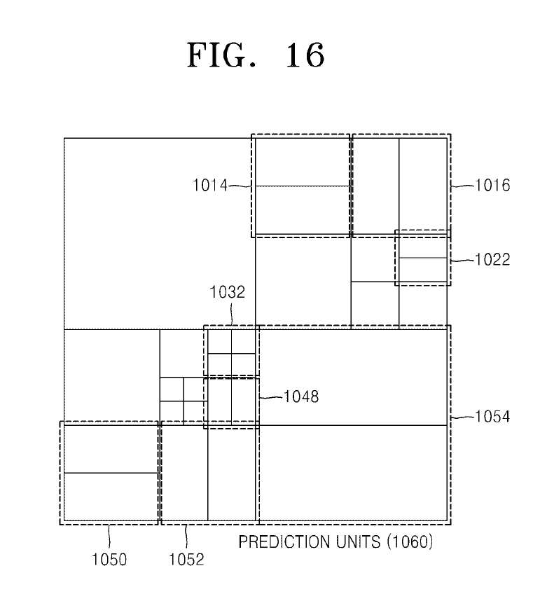

FIGS. 15, 16, and 17 are diagrams for describing a relationship between coding units 1010, prediction units 1060, and transformation units 1070, according to an exemplary embodiment. The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | |
|---|---|---|---|---|---|
| (Encoding on Coding Unit Having Size of 2N × 2N and Current Depth of d) | | | | | |
| | | | Size of Transformation Unit | | |
| | | | Split | Split | |
| | Partition Type | | Information 0 | Information 1 | |
| | Symmetrical | Asymmetrical | of | of | |
| Prediction | Partition | Partition | Transformation | Transformation | Split |
| Mode | Type | Type | Unit | Unit | Information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Type) | Coding Units |
| (Only | N × N | nR × 2N | | N/2 × N/2 | Having |
| 2N × 2N) | | | | (Asymmetrical | Lower Depth |
| | | | | Type) | of d + 1 |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoding information of the data units, and the searched adjacent coding units may be referred for predicting the current coding unit.

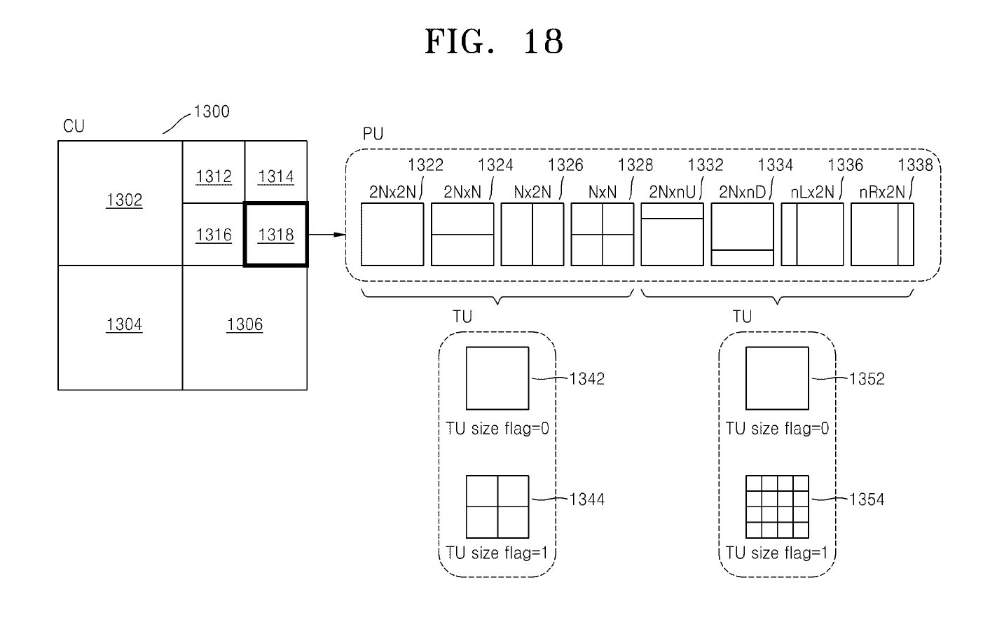

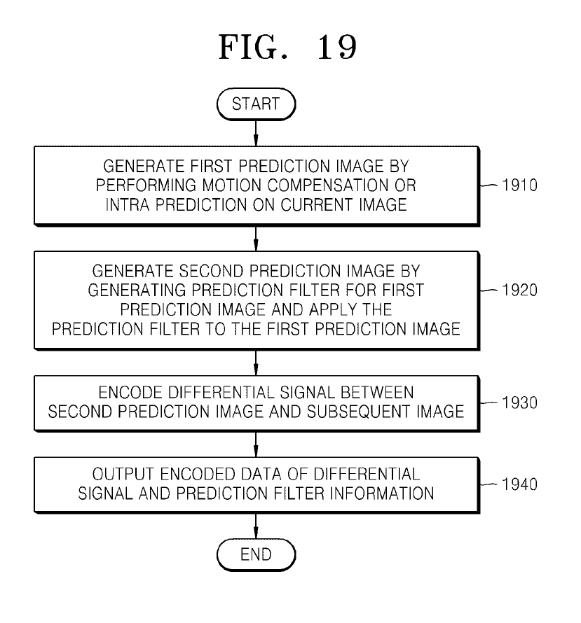

FIG. 18 is a diagram for describing a relationship between a coding unit, a prediction unit or a partition, and a transformation unit, according to encoding mode information of Table 1. A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU size flag) of a transformation unit is a type of a transformation index, and thus the size of a transformation unit corresponding to the transformation index may vary according to a prediction unit type or a partition type of a coding unit.

When the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

On the other hand, when the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 18, the TU size flag is a flag having a value or 0 or 1, but the TU size flag is not limited to 1 bit, and a transformation unit may be hierarchically split having a tree structure while the TU size flag increases from 0.

In this case, the size of a transformation unit that has been actually used may be expressed by using a TU size flag of a transformation unit, according to an exemplary embodiment, together with a maximum size and minimum size of the transformation unit. According to an exemplary embodiment, the video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. According to an exemplary embodiment, the video decoding apparatus 200 may decode video by using the maximum transformation unit size information, the minimum transformation unit size information, and the maximum TU size flag.

For example, if the size of a current coding unit is 64×64 and a maximum transformation unit size is 32×32, then the size of a transformation unit may be 32×32 when a TU size flag is 0, may be 16×16 when the TU size flag is 1, and may be 8×8 when the TU size flag is 2.

As another example, if the size of the current coding unit is 32×32 and a minimum transformation unit size is 32×32, then the size of the transformation unit may be 32×32 when the TU size flag is 0. Here, the TU size flag cannot be set to a value other than 0, since the size of the transformation unit cannot be less than 32×32.

As another example, if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) Equation (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an exemplary embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) Equation (2)

That is, if the current prediction mode is the inter mode, the transformation unit size ‘RootTuSize’ when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) Equation (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and is not limited thereto.

FIG. 19 is a flowchart illustrating a method of encoding a video employing adaptive prediction filtering, according to an exemplary embodiment.

In operation 1910, motion compensation or intra prediction is performed on a current image of an input video to generate an initial prediction image.

In operation 1920, in order to determine a prediction image for encoding a differential signal with respect to a subsequent image, a prediction filter for the initial prediction image is generated, and a final prediction image is generated by applying the prediction filter to the initial prediction image. The prediction filter is a filter applied to the initial prediction image in order to generate the final prediction image for maximizing the encoding efficiency of the differential signal between the subsequent image and the initial prediction image. A filter for generating a final prediction image having maximum efficiency of a differential signal that may be determined using Rate-Distortion Optimization from among final prediction images generated by applying various filters to the initial prediction image may be determined as a prediction filter.

When motion prediction and motion compensation according to an exemplary embodiment are performed based on a coding unit according to a hierarchical tree structure according to an exemplary embodiment, a prediction filter according to an exemplary embodiment may be determined based on the coding unit according to the hierarchical tree structure and a prediction unit. Alternatively, with respect to a prediction image generated based on the coding unit according to the hierarchical tree structure and the prediction unit, a prediction filtering data unit may be determined regardless of the coding unit according to the tree structure and the prediction unit.

When a current data unit is predicted by intra prediction when the initial prediction image is generated, a prediction image is reconstituted using information restored by motion compensation among adjacent data units of the current data unit, and the prediction filter may be determined based on the initial prediction image.

In operation 1930, the differential signal between the final prediction image and the subsequent image is transformed, quantized and entropy encoded to encode the differential signal.

In operation 1940, prediction filter information is output to be encoded to contain information related to encoded data of the differential signal and the prediction filtering. For example, the prediction information may include at least one from among prediction filter size information that indicates a filter size of the prediction filter, prediction filter type information that indicates a type and filter coefficient of the prediction filter, information that indicates whether prediction filtering is performed on a predetermined data unit, information that indicates a filtering region of the predetermined data unit, information that indicates whether prediction filtering is performed on a predetermined region of the predetermined data unit, information that indicates the type of data unit on which the prediction filtering is to be performed, and information that indicates a filter coefficient of the prediction filter.

The prediction filter information may be sequentially encoded according to a data unit on which the differential signal is encoded. In addition, according to an exemplary embodiment, prediction filter information for a corresponding data unit may be set for each respective data unit on which prediction filtering is performed.

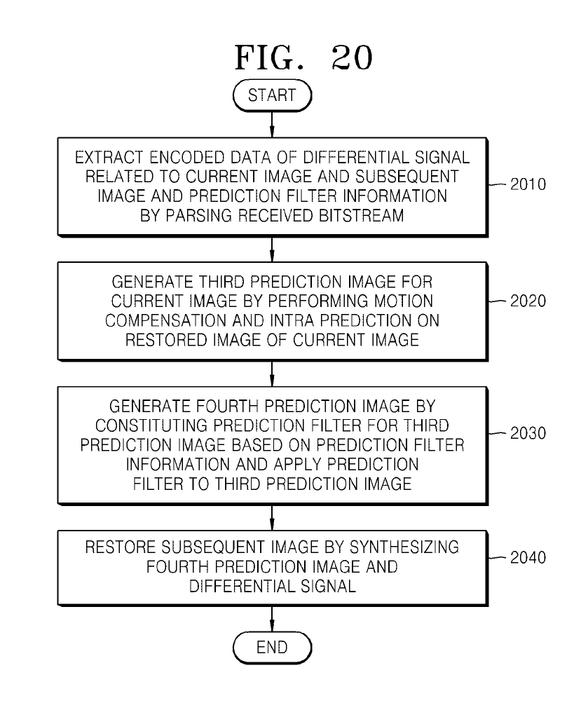

FIG. 20 is a flowchart illustrating a method of decoding a video employing adaptive prediction filtering, according to an exemplary embodiment.

In operation 2010, a received bitstream is parsed, and encoded data of a differential signal between a current image and a subsequent image of an original video, and prediction filter information are extracted from the parsed bitstream. Prediction filter information may be extracted for each respective data unit on which prediction filtering according to an exemplary embodiment is performed. In addition, prediction filter information may be sequentially extracted according to a coding unit of the encoded data of the differential signal.

In operation 2020, motion compensation and intra prediction are performed on a restored image of the current image to generate an initial prediction image of the current image. When the current data unit is restored by intra prediction while generating the prediction image, the initial prediction image may be reconstituted by reconstituting the current data unit by interpolating information by using motion compensation among adjacent information of the current data unit.

In operation 2030, a prediction filter for an initial prediction image for generating a final prediction image to be synthesized with the differential signal between the current image and the subsequent image is constituted based on the prediction filter information, and the final prediction image is generated by applying the prediction filter to the initial prediction image. The final prediction image may be generated by filtering the prediction filter by using a filtering method based on prediction filter information about the initial prediction image.

In operation 2040, the differential signal between the current image and the subsequent image, and the final prediction image are synthesized to restore a subsequent image. Loop filtering for a subsequent process for improving image quality, such as deblocking filtering, post filtering, or the like, may be further performed on a restored image. The restored image may be output in a restored frame, and reference may be made to the restored image for motion compensation of a subsequent frame.

Thus, encoding efficiency of the differential signal between the current image and the subsequent image is maximized by using adaptive prediction filtering according to an exemplary embodiment, and thus video encoding efficiency based on prediction encoding may be improved.

In addition, a region and data unit on which prediction filtering is to be performed, as well as the size, type and filter coefficient of an adaptive prediction filter may be selectively determined according to temporal characteristics and spatial characteristics of the prediction image and original image. Thus, video encoding efficiency may be increased by performing adaptive prediction filtering on the prediction image and the original image.

Since information required to determine an adaptive prediction filter and information required to perform adaptive prediction filtering are encoded and are transmitted together with encoded image data, a video may be optimally encoded by using adaptive prediction filtering in terms of video decoding.

The exemplary embodiments may be embodied as computer programs and can be implemented in general-use digital computers that execute the programs using processor and memory. Examples of the computer readable recording medium include magnetic storage media (e.g., ROM, floppy disks, hard disks, etc.) and optical recording media (e.g., CD-ROMs, or DVDs). Alternatively, the exemplary embodiments may be embodied as signals computer-readable transmission media, such as data signals, for transmission over a computer network, for example the Internet.

The video encoding apparatuses or video decoding apparatuses of the exemplary embodiments may include a bus coupled to every unit of the apparatus, at least one processor connected to the bus that executes commands, and a memory connected to the bus that stores commands, received messages, and generated messages.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a video, the method comprising:
performing motion compensation and intra prediction on a first image of the video and generating a first prediction image from the motion compensated and intra predicted first image;
generating a prediction filter based on at least one of characteristics of the first image and characteristics of the first prediction image;
filtering the first prediction image using the generated prediction filter and generating a second prediction image from the filtered first prediction image;
generating a differential signal between the generated second prediction image and a second image of the video;
encoding the generated differential signal; and
outputting the encoded differential signal and encoded prediction filter information, the encoded prediction filter information identifying characteristics of the prediction filter that permits reconstruction of the prediction filter by a decoding apparatus that receives the output encoded prediction filter information.

2. The method of claim 1, wherein generating the prediction filter comprises adaptively generating the prediction filter for maximizing encoding efficiency of the differential signal.

3. The method of claim 1, wherein the filtering comprises:
performing prediction filtering on the first prediction image by using a first prediction filter and a second prediction filter, the first prediction filter and the second prediction filter having different filter sizes and different filter coefficients; and
determining a filter size of the prediction filter by comparing results of the prediction filtering using the first prediction filter and the prediction filtering using the second prediction filter,
wherein the prediction filter information comprises prediction filter size information indicating the filter size of the prediction filter and a filter coefficient of the prediction filter, based on a result of the comparing.

4. The method of claim 1, wherein the filtering comprises:
performing prediction filtering on the first prediction image by using a one-dimensional prediction filter and performing prediction filtering on the first prediction image by using a two-dimensional prediction filter; and
determining a type and a filter coefficient of the prediction filter by comparing results of the prediction filtering using the one-dimensional prediction filter and the prediction filtering using the two-dimensional prediction filter,
wherein the prediction filter information comprises prediction filter type information indicating the type of the prediction filter and the filter coefficient of the prediction filter, based on a result of the comparing.

5. The method of claim 1, wherein the generating of the second prediction image comprises determining whether the filtering is performed on a predetermined data unit of the first prediction image,
wherein the predetermined data unit comprises at least one of a coding unit, a maximum encoding unit, a slice, a frame, a picture, and an image sequence, and
wherein the prediction filter information comprises information that indicates whether the filtering is performed on the predetermined data unit.

6. The method of claim 5, wherein the determining whether prediction filtering is performed comprises determining whether the filtering is performed on at least one region of an entire portion, a boundary portion, and an internal region other than the boundary region of the predetermined data unit, and
wherein the prediction filter information comprises information that indicates whether prediction filtering is performed on the determined at least one region of an entire portion, a boundary portion, and an internal region other than the boundary region of the predetermined data unit.

7. The method of claim 1, wherein the filtering comprises:
performing prediction filtering based on a first data using having a first size in the first prediction image and a second data unit having a second size in the first prediction unit; and
determining a type of a data unit on which prediction filtering for generating the second prediction image is to be performed by comparing results of the prediction filtering using the first data unit and the prediction filtering using the second data unit,
wherein the prediction filter information comprises information that indicates the type of data unit on which the prediction filtering is to be performed, based on a result of the determining.

8. The method of claim 7, wherein the outputting of the prediction filter information comprises sequentially generating and encoding the prediction filter information according to the data unit on which the prediction filtering is to be performed.

9. The method of claim 7, wherein the outputting of the prediction filter information comprises generating and encoding the prediction filter information according to a hierarchical tree structure of the data unit on which the prediction filtering is to be performed.

10. The method of claim 1, wherein the generating of the second prediction image comprises, when a current data unit of the first prediction image is obtained by intra prediction, generating the prediction filter for the current data unit by using data interpolated using information restored by motion compensation among adjacent data of the current data unit.

11. The method of claim 1, further comprising:
synthesizing the second prediction image and the differential signal to generate a restored image;
performing deblocking filtering on the restored image to update the restored image; and
performing motion compensation on the second image of the video with reference to the restored image.

12. The method of claim 1, further comprising:
determining a post filter that minimizes an amount of errors between the first image and a restored image formed by synthesizing the second prediction image and the differential image and performing post filtering for applying the post filter to the restored image; and
performing motion compensation of the second image of the video with reference to the restored image.

13. The method of claim 1, further comprising performing intra prediction, inter prediction, transformation and quantization on each maximum coding unit for a current picture of an image, split from the current picture, according to at least one coding unit according to depth, for each region that is hierarchically split and reduced from the maximum coding unit as the depth of the maximum coding unit deepens, determining a coded depth having a least amount of encoding errors based on the performing, and determining an encoding mode for indicating an encoding method based on a coding unit of the coded depth to determine coding units according to a tree structure for the maximum coding unit,
wherein the generating the prediction filter comprises generating the prediction filter for the current image of the coding unit of the coded depth.

14. The method of claim 1, wherein the performing comprises performing motion compensation on the first image according to at least one coding unit according to depth, for each region that is hierarchically split and reduced from a maximum coding unit as a depth of the maximum coding unit deepens and determining an encoding mode that indicates an encoding method based on the coding unit of the coded depth,
wherein the generating of the second prediction image comprises determining an encoded depth for generating a minimum amount of encoding errors by performing intra prediction and inter prediction based on a coding unit according to depths, prediction filtering using a prediction filter, transformation and quantization on the first prediction image, and determining an encoding mode that indicates an encoding method based on a coding unit of the encoded depth to determine coding units according to a tree structure for the maximum coding unit; and
generating prediction filters used in encoding units according to the tree structure for generating the minimum amount of encoding errors,
wherein the generating the differential signal comprises performing transformation, quantization and entropy encoding on a differential signal between the second prediction image and the second image generated by prediction filtering using prediction filters generated for the coding units according to the tree structure,
wherein the outputting of the prediction filter information comprises encoding information about prediction filtering using prediction filters used in the coding units according to the tree structure.

15. A method of decoding a video, the method comprising:
parsing a received bitstream and extracting prediction filter information that identifies characteristics of a prediction filter characteristics of a prediction filter that encodes the video and an encoded differential signal between a first image of the video and a second image of the video from the parsed bitstream;
performing at least one of motion compensation or intra prediction on a restored image of the first image to generate a first prediction image of the first image;
generating the prediction filter, based on the prediction filter information, and filtering the first prediction image using the generated prediction filter and generating a second prediction image from the filtered first prediction image; and
synthesizing the second prediction image and the differential signal to restore the second image.

16. The method of claim 15, wherein the performing comprises entropy decoding, inverse quantizing and inverse transforming the extracted encoded data to restore the differential signal, and synthesizing the restored differential signal and a prediction image of a previous image to generate the restored image of the first image; and
generating the first prediction image by performing intra prediction or motion compensation on the restored image of the first image.

17. The method of claim 15, wherein the synthesizing comprises:
performing entropy decoding, inverse quantization and inverse transformation on the encoded differential signal; and
synthesizing the second prediction image and the decoded differential signal.

18. The method of claim 15, wherein the generating the prediction filter comprises generating the prediction filter determined to minimize an amount of errors between the second image and the second prediction image using rate-distortion optimization based on the prediction filter information.

19. The method of claim 15, wherein the generating the prediction filter comprises generating the prediction filter according to a filter size and a filter coefficient, based on prediction filter size information that indicates the filter size and a filter coefficient of the prediction filter information.

20. The method of claim 15, wherein the generating of the prediction filter comprises generating the prediction filter according to a filter type and a filter coefficient, based on prediction filter type information that indicates the filter type and a filter coefficient of the prediction filter information.

21. The method of claim 15, further comprising determining whether filtering is performed on a predetermined data unit of the first prediction image, based on information of the prediction filter information, that indicates whether prediction filtering is performed on the predetermined data unit,
wherein the predetermined data unit comprises at least one of a coding unit, a maximum coding unit, a slice, a frame, a picture and an image sequence.

22. The method of claim 21, further comprising determining whether prediction filtering is performed on at least one region of an entire portion, a boundary portion and an internal region other than the boundary region of the predetermined data unit, based on information of the prediction filter information, that indicates whether prediction filtering is performed on the at least one region of an entire portion, the boundary portion and the internal region other than the boundary region of the predetermined data unit.

23. The method of claim 15, wherein the generating the prediction filter comprises determining a type of a data unit on which prediction filtering is to be performed, based on information of the prediction filter information, that indicates the type of data unit on which the prediction filtering is to be performed.

24. The method of claim 23, wherein the extracting of the prediction filter information comprises sequentially extracting the prediction filter information according to an order of data units on which the prediction filtering is to be performed.

25. The method of claim 23, wherein the extracting of the prediction filter information comprises extracting the prediction filter information according to a hierarchical order of data units on which the prediction filtering is to be performed.

26. The method of claim 15, further comprising, when a current data unit of the first prediction image is restored by intra prediction, performing prediction filtering using the prediction filter on data interpolated using information that is restored by motion compensation among adjacent data of the current data unit.

27. The method of claim 17, wherein the synthesizing comprises synthesizing the second prediction image and the differential signal and performing deblocking filtering,
wherein the restored image of the second image is a third prediction image of the second image.

28. The method of claim 17, further comprising determining a post filter that minimizes an amount of errors between the first image and the restored second image formed by synthesizing the second prediction image and the differential signal and applying the determined post filter to the restored second image to generate an updated restored second image,
wherein the updated restored second image is a third prediction image of the second image.

29. The method of claim 15, further comprising:
extracting coding unit data, encoding mode information that indicates an encoding mode and the prediction filter information, for each coding unit of an encoded depth, from the parsed bitstream, based on coding units according to a tree structure comprising coding units of the encoded depth as a depth for generating a minimum encoding error by performing intra prediction, inter prediction, transformation and quantization according to at least one coding unit according to depth, for each region that is hierarchically split and reduced from the maximum coding unit as the depth of the maximum coding unit deepens and determining an encoding mode for indicating an encoding method based on the coding unit of the coded depth; and
decoding the encoded image data by performing inverse quantization, inverse transformation, intra prediction, and motion compensation based on the encoded depth and the encoding mode, based on the encoding mode information,
wherein the prediction filtering is performed based on a coding unit of the encoded depth, based on the prediction filter information.

30. The method of claim 15, wherein the extracting of the prediction filter information and the encoded data comprises extracting coding unit data, encoding mode information that indicates an encoding mode and the prediction filter information, based on coding units according to a tree structure comprising coding units of the encoded depth as a depth for generating a minimum encoding error by performing intra prediction and inter prediction, and frequency transformation and quantization according to at least one coding unit according to depth, for each region that is hierarchically split and reduced from the maximum coding unit as the depth of the maximum coding unit deepens and determining an encoding mode for indicating an encoding method based on the coding unit of the coded depth,
the method further comprising decoding image data of the encoded image by inverse quantization, inverse transformation, intra prediction, motion compensation and prediction filtering according to the encoding mode for each coding unit of the encoded depth, based on the encoding mode information.

31. A video encoding apparatus comprising:
a prediction image generator that performs motion compensation and intra prediction on a first image of a video and generates a first prediction image from the motion compensated and intra predicted first image;
a prediction filtering unit that generates a prediction filter based on at least one of characteristics of the first image and characteristics of the first prediction image filters the first prediction image using the generated prediction filter, and generates a second prediction image from the filtered first prediction image;
an image encoder that generates a differential signal between the generated second prediction image and a second image of the video and encodes the generated; and
an output unit that outputs the encoded differential signal and encoded prediction filter information, the encoded prediction filter information identifying characteristics of the prediction filter that permits reconstruction of the prediction filter by a decoding apparatus that receives the output encoded prediction filter information.

32. A video decoding apparatus comprising:
a data extractor that parses a received bitstream and extracts prediction filter information that identifies characteristics of a prediction filter characteristics of a prediction filter that encodes a video in the bitstream and an encoded differential signal between a first image the video and a second image of the video from the bitstream;
a differential signal decoder that entropy decodes, inverse quantizes, and inverse transforms the encoded differential signal;
a prediction image generator that performs motion compensation or intra prediction on a restored image of the first image;
a prediction filtering unit that generates the prediction filter, based on the prediction filter information, filters the first prediction image using the generated prediction filter, and generates a second prediction image from the filtered first prediction image; and
an image restorer that synthesizes the second prediction image and the differential signal to restore the second image.

33. A computer readable recording medium having recorded thereon a program for executing the method of claim 1.

34. A computer readable recording medium having recorded thereon a program for executing the method of claim 15.
